(19) United States
(12) Patent Application Publication
(10) Pub. No.: US 2017/0082853 A1
(43) Pub. Date: Mar. 23, 2017

(54) IMAGE CONTROL APPARATUS

(71) Applicant: FUJITSU TEN LIMITED, Kobe-shi (JP)

(72) Inventor: Takumi YOSHIMOTO, Kobe-shi (JP)

(73) Assignee: FUJITSU TEN LIMITED, Kobe-shi (JP)

(21) Appl. No.: 15/258,416

(22) Filed: Sep. 7, 2016

(30) Foreign Application Priority Data
Sep. 18, 2015 (JP) 2015-185335

(51) Int. Cl. G02B 27/01

(52) U.S. Cl. CPC G02B 27/0101; G02B 2027/0138; G02B 2027/0183

(57) ABSTRACT

A display screen of a display apparatus in an image display system includes a one-way mirror on a front side of the display screen. Moreover, an image obtaining part of a display control apparatus obtains a captured image captured by a camera that captures an image of surroundings of a vehicle. The image display system includes, as operation modes, an image display mode that displays the captured image on the display apparatus and a mirror mode that causes the display apparatus to be in a non-display state to cause the display screen of the display apparatus to function as a mirror. A determination part determines a state of the vehicle based on a signal relating to the vehicle and a mode setter sets the operation mode based on the state of the vehicle.

### BACKGROUND OF THE INVENTION

Field of the Invention

This invention relates to a technology for displaying an image showing surroundings of a vehicle.

Description of the Background Art

Generally, a driver of a vehicle, such as a car, sees a surrounding area behind the vehicle by looking at an interior rearview mirror provided in a cabin of the vehicle. However, even if the driver uses the interior rearview mirror, there is a case where it is difficult for the driver to see the surrounding area behind the vehicle because driver's view is blocked by luggage and the like in a rear area of the cabin of the vehicle. Moreover, in a case of a truck having a container and the like, there is a case where the interior rearview mirror cannot be used to see the surrounding area behind the vehicle.

Therefore, an image display system has been recently proposed that obtains images of the surrounding area behind the vehicle by capturing the images with a camera, and that causes the captured images to be displayed on a display apparatus provided to a position of the interior rearview mirror in the cabin of in the vehicle. The driver of the vehicle that is a user of the image display system, can stably see the surrounding area behind the vehicle without influence of luggage and the like in the rear area of the cabin of the vehicle.

However, there is a case where the driver of the vehicle uses a conventional interior rearview mirror to see not only the surrounding area behind the vehicle but also the occupant, luggage, etc. in the rear area of the cabin of the vehicle. Since the foregoing image display system does not display an image showing the cabin of the vehicle, it is impossible for the user to see a situation of the rear area of the cabin of the vehicle.

Therefore, an image display system including a display apparatus having a display screen using a one-way mirror has been proposed. The image display system causes the display apparatus to be in a non-display state and darkens an inside of the one-way mirror. Thus, the display screen of the display apparatus functions as a mirror to show an image of an object in the rear area of the cabin of the vehicle.

However, in a case where such an image display system is used, operation modes are switched by an operation made by the user between operation modes, one of which displays the captured image on the display apparatus and the other of which causes a display screen of the display apparatus to function as a mirror. However, there are cases where the user feels it troublesome to change the operation modes. Thus, the driver may continue driving of the vehicle while having the image display system in an operation mode inappropriate to a state of the vehicle.

### SUMMARY OF THE INVENTION

According to one aspect of the invention, a display control apparatus controls a display apparatus having a display screen that includes a one-way mirror. The display control apparatus includes a controller configured to: obtain a captured image captured by a camera that captures an image of surroundings of a vehicle on which the display apparatus is provided; determine a state of the vehicle based on a signal relating to the vehicle, the signal obtained by the controller; and set an operation mode of the display apparatus based on the determined state of the vehicle. The operation mode is one of a first mode that displays the captured image on the display apparatus and a second mode that causes the display apparatus to be in a non-display state so that the display screen of the display apparatus functions as a mirror.

Thus, since the operation mode is set based on the state of the vehicle, the operation mode can be changed to one of the operation modes that is suitable to the state of the vehicle, without an operation made by a user.

According to another aspect of the invention, the controller determines whether the state of the vehicle is a travelling state or a stopped state based on the signal relating to the vehicle, and in a case where the state of the vehicle is determined to be the travelling state, the controller sets the operation mode to the first mode, and in a case where the state of the vehicle is determined to be the stopped state, the controller sets the operation mode to the second mode.

Thus, in the case where the state of the vehicle is determined to be the travelling state, the operation mode is set to the first mode. Therefore, the user can see the situation of the surroundings of the vehicle. Moreover, in a case where the state of the vehicle is determined to be the stopped state, the operation mode is set to the second mode. Therefore, the user can see the situation in the cabin of the vehicle.

Thus, an object of the invention is to provide a technology for changing an operation mode to one of the operation modes that is suitable to a state of a vehicle, without an operation made by a user.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 illustrates an outline of an image display system;

FIG. 2 illustrates a front area of a cabin of a vehicle;

FIG. 3 illustrates a block diagram showing a configuration of the image display system;

FIG. 4 illustrates a main configuration of a display screen of a display apparatus;

FIG. 5 illustrates examples of states of the display apparatus;

FIG. 6 illustrates a process flow of the image display system in the first embodiment;

FIG. 7 illustrates a flow of a state determination process in the first embodiment;

FIG. 8 illustrates a flow of a state determination process in the second embodiment;

FIG. 9 illustrates a process flow of an image display system in the third embodiment;

FIG. 10 illustrates a flow of a state determination process in the third embodiment; and

FIG. 11 illustrates a flow of a state determination process in the fourth embodiment.

### DESCRIPTION OF THE EMBODIMENTS

Embodiments of the invention will be hereinafter described with reference to the drawings.

### 1. First Embodiment

### 1-1. Outline of Image Display System

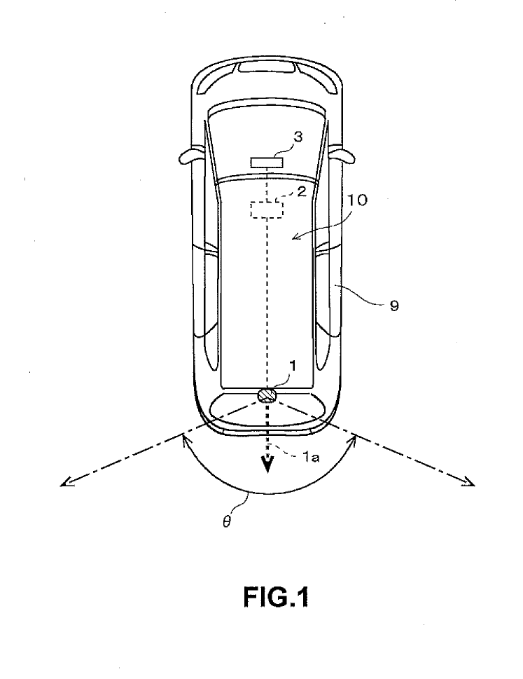

FIG. 1 illustrates an outline of an image display system 10. As shown in FIG. 1, the image display system 10 is mounted on a vehicle (a car in this embodiment) 9. The image display system 10 includes: a camera 1 that captures images of surroundings of the vehicle 9; a display apparatus 3 that is provided in a cabin of the vehicle 9; and a display control apparatus 2 that entirely controls the image display system 10. The image display system 10 obtains the captured images of the surroundings of the vehicle 9, using the camera 1, and displays the captured images on the display apparatus 3 in the cabin of the vehicle 9.

The camera 1 includes a lens and an image sensor, and electronically captures the captured images including an image of a subject in the surroundings of the vehicle 9. The camera 1 is mounted in an upper area of a rear end of the vehicle 9, having an optical axis 1a directed rearward in a front-back direction of the vehicle 9. Therefore, the camera 1 captures the images of the subject existing in a surrounding area behind the vehicle. The lens of the camera 1 is a wide-angle lens and the camera 1 has a relatively wide angle of field θ. Therefore, the camera 1 is configured to capture images of a relatively wide region of the surrounding area behind the vehicle 9.

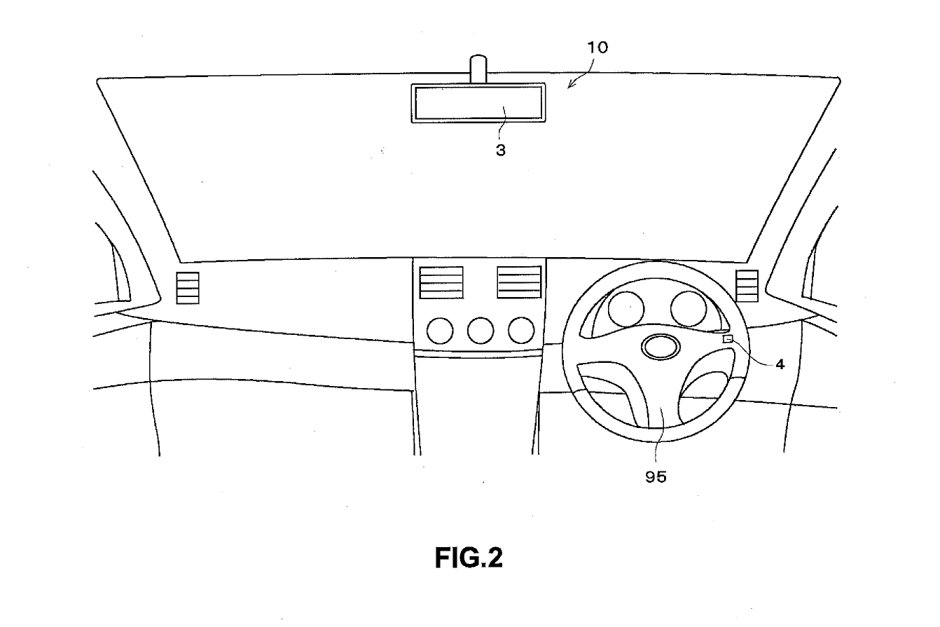

FIG. 2 illustrates a front area of the cabin of the vehicle 9. As shown in FIG. 2, in the vehicle 9 in which the image display system 10 is mounted, the display apparatus 3 is provided, instead of an interior rearview mirror, in a location in which the interior rearview mirror is usually provided in the cabin of the vehicle 9. The display apparatus 3 displays the captured images that are captured by the camera 1 and that show the surrounding area behind the vehicle 9. Therefore, a user (typically a driver of the vehicle 9) of the image display system 10 can see a situation of the surrounding area behind the vehicle 9 by seeing the captured images displayed on the display apparatus 3.

Moreover, the image display system 10 is also configured to cause a display screen of the display apparatus 3 to function as a mirror that reflects visible light. The user sees an image of an object in the cabin on the display screen of the display apparatus 3 functioning as the mirror to see a situation of an occupant, luggage, etc. in a rear area of the cabin of the vehicle 9.

As described above, the image display system 10 includes functions of displaying the captured images on the display apparatus 3 and of causing the display screen of the display apparatus 3 to function as the mirror. One of these functions is executed depending on an operation mode of the image display system 10. In other words, the image display system 10 includes two operation modes, one of which is an image display mode that causes the captured images to be displayed on the display apparatus 3, and the other of which is a mirror mode that causes the display screen of the display apparatus 3 to function as the mirror. The image display system 10 is configured to set one of the two modes that is suitable to a state of the vehicle 9, without an operation by the user.

### 1-2. Configuration of Image Display System

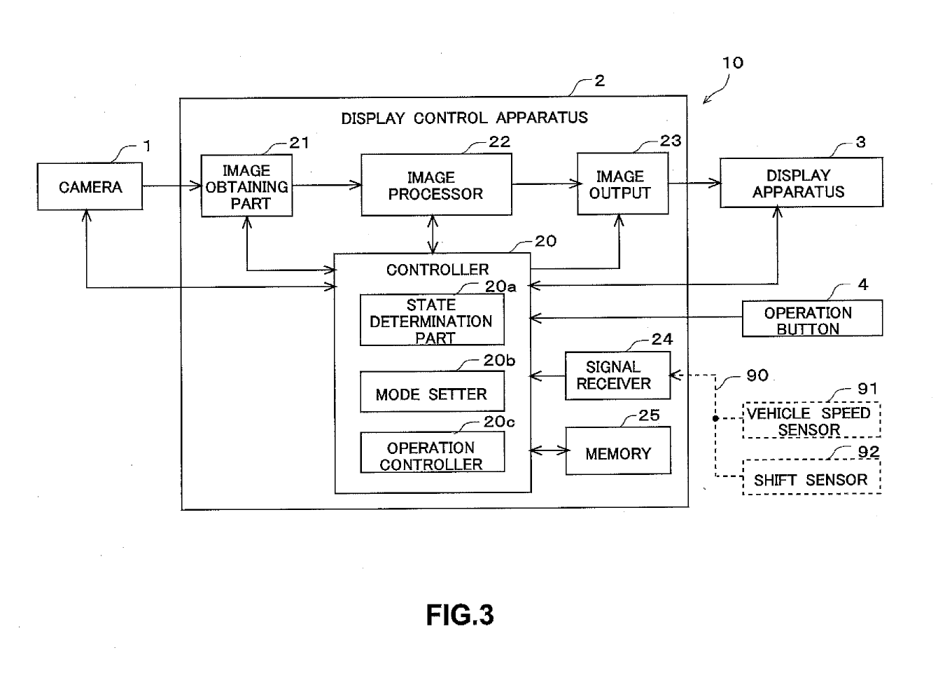

FIG. 3 illustrates a block diagram showing a configuration of the image display system 10. The image display system 10 includes the camera 1, the display apparatus 3, the display control apparatus 2, as described above, and an operation button 4 that receives operations by the user. The camera 1, the display apparatus 3 and the operation button 4 are electrically connected to the display control apparatus 2.

The operation button 4 is an operation member that receives the operations by the user. The operation button 4 is provided on, for example, a steering wheel 95 of the vehicle 9 (refer to FIG. 2). The operation button 4 may be provided to another location in the vehicle 9, such as an area near the display screen of the display apparatus 3.

The display control apparatus 2 performs various types of image processing so as to make the captured images captured by the camera 1 suitable to be displayed on the display apparatus 3. The display control apparatus 2 includes an image obtaining part 21, an image processor 22 and an image output 23.

The image obtaining part 21 obtains the captured images captured by the camera 1. The image processor 22 preforms various types of image processing, such as distortion correction, luminance adjustment, and size change, of the captured images captured by the image obtaining part 21. Thus, the image processor 22 changes a format, size, etc. of the captured images so as to be suitable to be displayed on the display apparatus 3. The image output 23 outputs the captured images processed by the image processor 22, to the display apparatus 3. Thus, the captured images are displayed on the display screen of the display apparatus 3.

Moreover, the display control apparatus 2 further includes a controller 20, a signal receiver 24 and a memory 25.

The signal receiver 24 receives signals relating to the vehicle 9 sent from other apparatuses installed in the vehicle 9, via a vehicle-mounted network 90. The signal receiver 24 inputs the received signal to the controller 20. A few among the other apparatuses installed in the vehicle 9 are a vehicle speed sensor 91 and a shift sensor 92. The signal receiver 24 receives a speed signal indicative of a speed of the vehicle 9, from the vehicle speed sensor 91. Moreover, the signal receiver 24 receives a shift signal indicative of a position of a gearshift of a transmission of the vehicle 9, from the shift sensor 92.

The memory 25 is, for example, a non-volatile memory, such as a flash memory, and stores various types of information. The memory 25 stores a program as firmware and various types of data.

The controller 20 is a microcomputer including, for example, a CPU, a RAM, a ROM, etc., and comprehensively controls the entire image display system 10. The controller 20 is electrically connected to each of the camera 1, the display apparatus 3 and other processing portions of the image display system 10, and is configured to control operation of each processing portion by sending a signal to each processing portion. Moreover, when the user makes an operation with the operation button 4, a signal indicative of a content of the operation is input to the controller 20.

Various functions of the controller 20 are realized by execution of the programs stored in the memory 25 (arithmetic processing performed by the CPU according to the programs). A state determination part 20a, a mode setter 20b and an operation controller 20c shown in FIG. 3 are part of functions realized by the execution of the programs.

The state determination part 20a determines a state of the vehicle 9 based on a signal relating to the vehicle 9 received by the signal receiver 24. The mode setter 20b sets, for the image display system 10, one of the operation modes based on the state of the vehicle 9 determined by the state determination part 20a. The operation controller 20c controls the processing portions of the image display system 10 to work according to the operation mode set by the mode setter 20b. Those functions will be described later in detail.

### 1-2. Display Apparatus Functioning as a Mirror

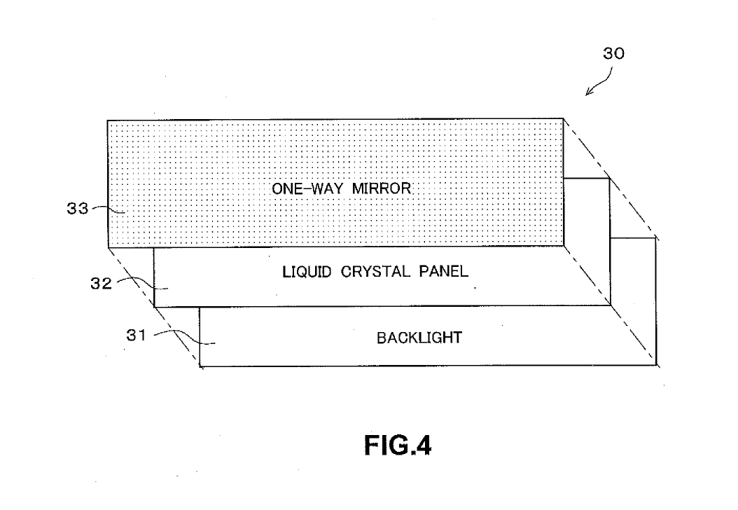

Next, the display apparatus 3 will be described more in detail. FIG. 4 illustrates a main configuration of a display screen 30 of the display apparatus 3. As shown in FIG. 4, the display screen 30 of the display apparatus 3 includes a backlight 31 and a liquid crystal panel 32. The liquid crystal panel 32 is provided on a front side of the backlight 31. When the display screen 30 displays an image, the liquid crystal panel 32 lets light of the backlight 31 pass through according to a value of each pixel included in the image to be displayed.

Moreover, the display screen 30 further includes a one-way mirror 33 on a front side (a side from which the user sees) of the liquid crystal panel 32. The one-way mirror 33 is also called half-silvered mirror or mirror glass and is an apparatus (beam splitter) that has a property of reflecting some incident light and letting other pass through.

When looking at a one-way mirror placed in a boundary between a dark side and a bright side from the dark side, a person sees an object existing on an opposite side (bright side) through the one-way mirror. On the other hand, when looking at the one-way mirror from the bright side, the person sees an image of the object existing on a side of the person (bright side) on the one-way mirror. In other words, the one-way mirror functions as a mirror that reflects visible light.

Due to such a property of the one-way mirror 33, the display screen 30 including the one-way mirror 33 on the front side of the liquid crystal panel 32 also functions as the mirror showing an image of an object. It is recommended that transmittance and reflectance of the one-way mirror 33 used for the display screen 30 should be set, considering visibility of the display screen 30, and the transmittance does not have to be matched to the reflectance.

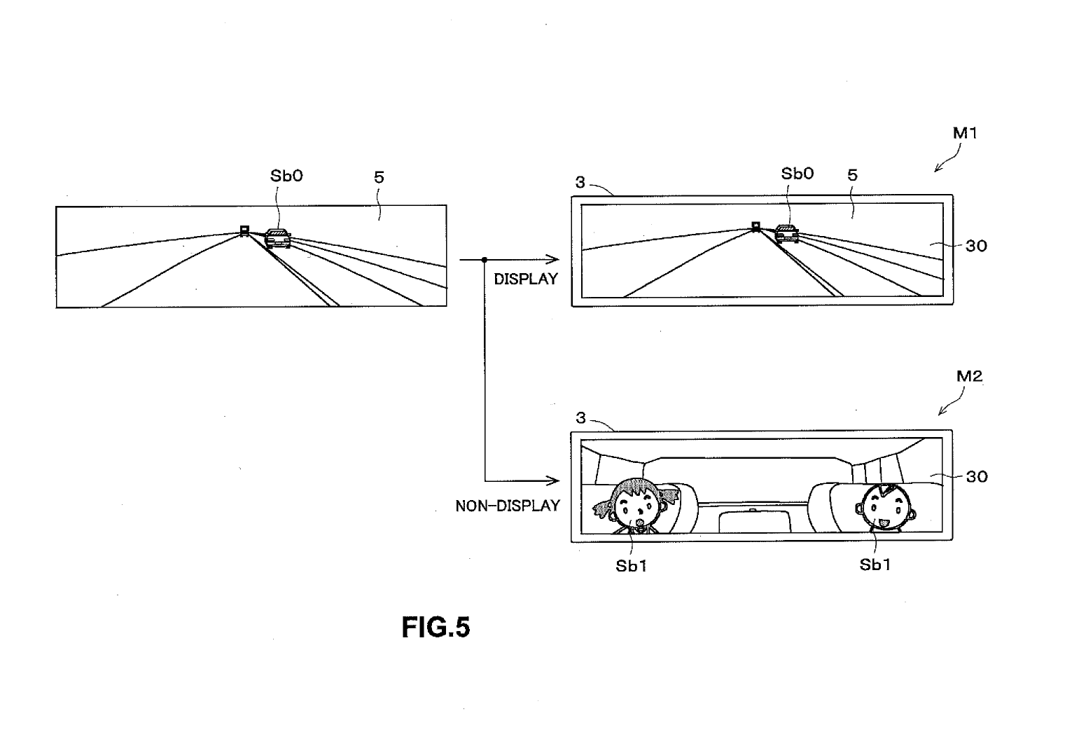

FIG. 5 illustrates examples of states of the display apparatus 3. In a case where the display apparatus 3 displays a captured image 5 captured by the camera 1, as shown in a left drawing of FIG. 5, the captured image 5 is displayed on the display screen 30 of the display apparatus 3, as shown in an upper right drawing of FIG. 5. Due to light of the backlight 31, an inner side of the one-way mirror 33 is bright so that the user sees a subject Sb0 on the brightly-lit captured image 5. Thus, based on the principle, the user can see the situation of the surrounding area behind the vehicle 9 in an image display mode M1.

Next, in order to cause the captured image 5 not to be displayed on the display apparatus 3 (in a case where the display apparatus 3 is caused to be in a non-display state), the display apparatus 3 turns off the backlight 31 (switch off the backlight 31). Thus, the display apparatus 3 becomes in the non-display state. In this case, as shown in a lower right drawing of FIG. 5, the display screen 30 of the display apparatus 3 functions as the mirror that reflects visible light. In this case, since the inner side of the one-way mirror 33 is dark, the user sees an image Sb1 of the object in the one-way mirror 33. Thus, based on the principle, the user can see the situation of the occupant and luggage in the rear area of the cabin of the vehicle 9 in a mirror mode M2.

### 1-4. Process of Image Display System

Next described is a process flow of the image display system 10. In the image display system 10, the state determination part 20a of the display control apparatus 2 determines the state of the vehicle 9, and the mode setter 20b sets the operation mode based on the state of the vehicle 9.

While driving the vehicle 9, the user (the driver of the vehicle 9) needs to exactly understand the situation of the surrounding of the vehicle 9. Therefore, while the vehicle 9 is travelling, it is recommended that the image display mode should be set because the situation of the surrounding area behind the vehicle 9 can be confirmed. However, the user (the driver of the vehicle 9) usually sees the situation of the rear area of the cabin of the vehicle 9 when the vehicle 9 is stopped. Therefore, while the vehicle 9 is stopped, it is recommended that the mirror mode should be set because the situation of the rear area of the cabin of the vehicle 9 can be confirmed.

Therefore, the state determination part 20a of the display control apparatus 2 of the image display system 10 determines whether the state of the vehicle 9 is a travelling state or a stopped state. Then, in a case where the state of the vehicle 9 is determined to be the travelling state, the mode setter 20b of the display control apparatus 2 sets the operation mode to the image display mode. In a case where the state of the vehicle 9 is determined to be the stopped state, the mode setter 20b of the display control apparatus 2 sets the operation mode to the mirror mode. Thus, from amongst the operation modes, one suitable to the state of the vehicle 9 is selected without an operation by the user.

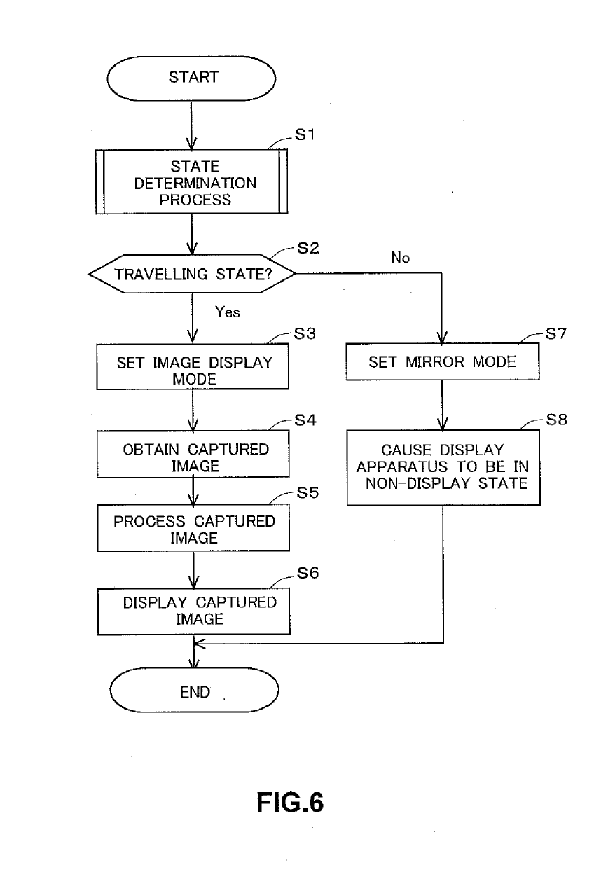

FIG. 6 illustrates the process flow of the image display system 10. The process shown in FIG. 6 is repeatedly performed in a predetermined time cycle (e.g., 1/30 sec. cycle).

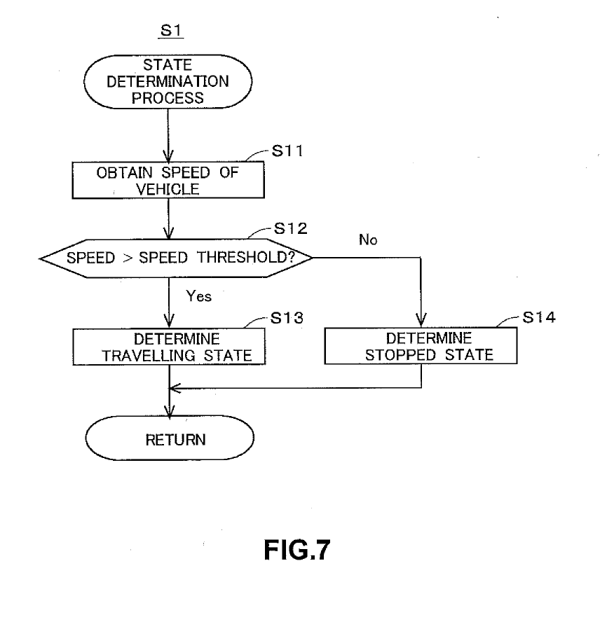

First, the state determination part 20a of the display control apparatus 2 performs a state determination process that determines the state of the vehicle 9 (a step S1). FIG. 7 illustrates a detailed flow of the state determination process.

In the state determination process, first, the state determination part 20a obtains a speed of the vehicle 9 at a current time point (a step S11). The state determination part 20a obtains the speed of the vehicle 9 based on the speed signal received by the signal receiver 24 from the vehicle speed sensor 91.

Next, the state determination part 20a compares the obtained speed of the vehicle 9 to a predetermined speed that is a threshold value (e.g., 0.1 km/h, hereinafter referred to as “speed threshold”) (a step S12).

Then, in a case where the speed of the vehicle 9 exceeds the speed threshold (Yes in the step S12), the state determination part 20a determines that the state of the vehicle 9 is the travelling state (a step S13). On the other hand, in a case where the speed of the vehicle 9 is equal to or below the speed threshold (No in the step S12), the state determination part 20a determines that the state of the vehicle 9 is the stopped state (a step S14).

With reference back to FIG. 6, as described above, after the state determination part 20a of the display control apparatus 2 performed the state determination process (the step S1), the mode setter 20b of the display control apparatus 2 receives the determined state of the vehicle 9 and then sets the operation mode based on the state of the vehicle 9 (a step S2 and after).

In the case where the state of the vehicle 9 is determined to be the travelling state (Yes in the step S2), the mode setter 20b of the display control apparatus 2 sets the operation mode to the image display mode (a step S3). After that, the operation controller 20c controls each processing portion of the image display system 10 to work according to the image display mode.

In other words, the image obtaining part 21 obtains the captured image from the camera 1 (a step S4), and the image processor 22 performs the image processing of the captured image so as to make the captured image suitable to be displayed on the display apparatus 3 (a step S5). Then, the image output 23 outputs the captured image to the display apparatus 3. Thus, the display apparatus 3 displays the captured image including the subject in the surrounding area behind the vehicle 9, on the display screen 30 (a step S6). Accordingly, the user can see the situation of the surrounding area behind the vehicle 9.

On the other hand, in the case where the state of the vehicle 9 is determined to be the stopped state (No in the step S2), the mode setter 20b of the display control apparatus 2 sets the operation mode to the mirror mode (a step S7). After that, the operation controller 20c controls each processing portion of the image display system 10 to work according to the mirror mode.

More specifically, the operation controller 20c sends a stop signal to the display apparatus 3, and causes the backlight 31 to be turned off to change the state of the display apparatus 3 to the non-display state (a step S8). Thus, the display screen 30 of the display apparatus 3 functions as the mirror that reflects the visible light. Accordingly, the user can see the situation of the occupant and the luggage in the rear area of the cabin of the vehicle 9.

In the mirror mode, the captured image is not needed. Therefore, the operation controller 20c may turn off the camera 1 and other processing portions relating to the captured images. Thus, it is possible to effectively reduce power consumption in the mirror mode by turning off the processing portions relating to the captured images along with the backlight 31.

As described above, in the image display system 10 of the first embodiment, the display screen 30 of the display apparatus 3 includes the one-way mirror 33 on the front side thereof. Moreover, the image obtaining part 21 of the display control apparatus 2 obtains the captured images from the camera 1 that captures images of the surroundings of the vehicle 9. The image display system 10 includes, as the operation modes, the image display mode that causes the captured image to be displayed on the display apparatus 3, and the mirror mode that causes the display screen 30 to function as the mirror by causing the display apparatus 3 to be in the non-display state. Then, the state determination part 20a determines the state of the vehicle 9 based on the signal relating to the vehicle 9, and the mode setter 20b sets the operation mode based on the state of the vehicle 9.

As described above, since the operation mode is set based on the state of the vehicle 9, the operation mode is changed to one of the operation modes that is suitable to the state of the vehicle 9 without an operation by the user.

Moreover, the state determination part 20a determines whether the state of the vehicle 9 is the travelling state or the stopped state. In the case where the state of the vehicle 9 is determined to be the travelling state, the mode setter 20b of the display control apparatus 2 sets the operation mode to the image display mode. Thus, the user can see the situation of the surrounding area of the vehicle 9. On the other hand, in the case where the state of the vehicle 9 is determined to be the stopped state, the mode setter 20b of the display control apparatus 2 sets the operation mode to the mirror mode. Thus, the user can see the situation of the cabin of the vehicle 9.

Moreover, since the state determination part 20a determines whether or not the state of the vehicle 9 is the travelling state or the stopped state based on the speed signal indicative of the speed of the vehicle 9, the state determination part 20a determines the state of the vehicle 9 easily.

### 2. Second Embodiment

Next, a second embodiment will be described. A configuration and a process of an image display system 10 in the second embodiment are substantially the same as the configuration and the process of the image display system 10 in the first embodiment. Therefore, a difference from the image display system 10 in the first embodiment will be mainly described below. In the first embodiment, the state determination part 20a determines, based on the speed signal indicative of the speed of the vehicle 9, whether the state of the vehicle 9 is the travelling state or the stopped state. However, in the second embodiment, a state determination part 20a determines, based on a shift signal indicative of a position of a gearshift of a transmission of a vehicle 9, whether a state of the vehicle 9 is the travelling state or the stopped state.

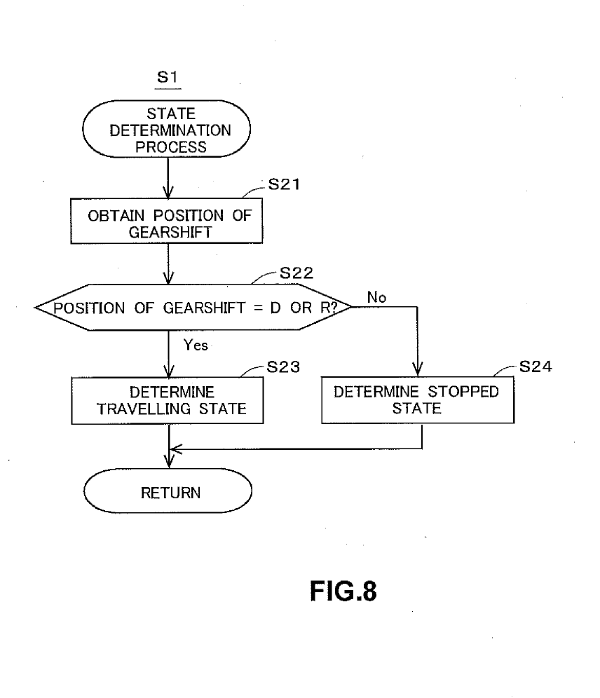

The process performed by the image display system 10 in the second embodiment is different from the process in the first embodiment, only in teens of the state determination process (the step S1 in FIG. 6). FIG. 8 illustrates a detailed flow of a state determination process in the second embodiment.

First, the state determination part 20a obtains the position of the gearshift of the vehicle 9 at a current time point (a step S21). The state determination part 20a obtains the position of the gearshift of the vehicle 9 based on the shift signal received by a signal receiver 24 from a shift sensor 92.

Next, the state determination part 20a determines that the position of the gearshift of the vehicle 9 is a park position (P), a reverse position (R), a neutral position (N) or a drive position (D) (a step S22).

In a case where the position of the gearshift of the vehicle 9 is the drive position (D) or the reverse position (R) (Yes in the step S22), the state determination part 20a determines that the state of the vehicle 9 is the travelling state (a step S23). On the other hand, in a case where the position of the gearshift of the vehicle 9 is the park position (P) or the neutral position (N) (No in the step S22), the state determination part 20a determines that the state of the vehicle 9 is the stopped state (a step S24).

The steps performed by the image display system 10 after the state determination part 20a performed the state determination process are the same as the steps in the first embodiment (FIG. 6). Therefore, in the case where the state of the vehicle 9 is determined to be the travelling state, a mode setter 20b sets the operation mode to the image display mode (the step S3), and in the case where the state of the vehicle 9 is determined to be the stopped state, the mode setter 20b sets the operation mode to the mirror mode (the step S7).

As described above, in the image display system 10 in the second embodiment, the state determination part 20a determines, based on the shift signal indicative of the position of the gearshift of the transmission of the vehicle 9, whether the state of the vehicle 9 is the travelling state or the stopped state. Therefore, the state of the vehicle 9 can be easily determined.

Moreover, since the state determination part 20a determines whether the state of the vehicle 9 is the travelling state or the stopped state, regardless of the speed of the vehicle 9, even if the vehicle 9 alternately repeats stop and travelling of a short time period, the operation mode is not changed so that the user can use the display apparatus 3 stably.

### 3. Third Embodiment

Next, a third embodiment will be descried below. A configuration and a process of an image display system 10 in the third embodiment are substantially the same as the configuration and the process of the image display system 10 in the first embodiment. Therefore, a difference from the image display system 10 in the first embodiment will be mainly described below. In the first embodiment, the state determination part 20a determines, only based on the speed signal indicative of the speed of the vehicle 9, whether the state of the vehicle 9 is the travelling state or the stopped state. However, in the third embodiment, a state determination part 20a determines a state of a vehicle 9 based on both a speed signal and a shift signal. Moreover, the state determination part 20a determines the state of the vehicle 9 from amongst three states of the travelling state, the stopped state and a backward-moving state.

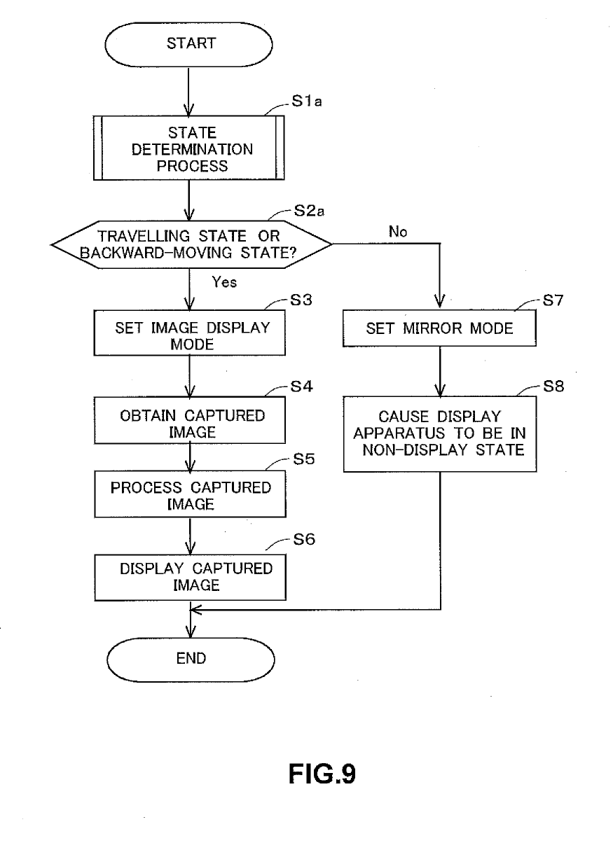

FIG. 9 illustrates a process flow of the image display system 10 in the third embodiment. The process flow illustrated in FIG. 9 is different from the process in the first embodiment, only in terms of steps S1a and S2a (the steps S1 and S2 in FIG. 6).

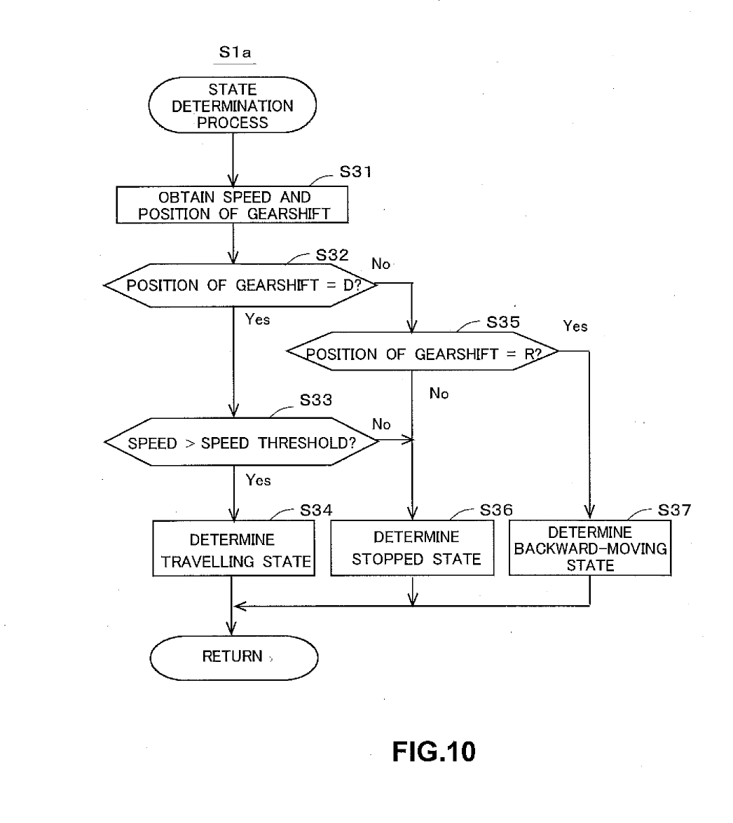

First, the state determination part 20a performs a state determination process that determines the state of the vehicle 9 (a step S1a). FIG. 10 illustrates a detailed flow of the state determination process (the step S1a) in the third embodiment.

In the state determination process, first, the state determination part 20a obtains a speed and a position of a gearshift of the vehicle 9 at a current time point (a step S31). The state determination part 20a obtains the speed of the vehicle 9 based on the speed signal, and also obtains the position of the gearshift of the vehicle 9 based on the shift signal.

Next, the state determination part 20a determines whether or not the position of the gearshift of the vehicle 9 is a drive position (D) (a step S32).

In a case where the position of the gearshift of the vehicle 9 is the drive position (D) (Yes in the step S32), the state determination part 20a determines whether the state of the vehicle 9 is the travelling state or the stopped state, based on the speed of the vehicle 9, same as the process in the first embodiment. In other words, the state determination part 20a compares the speed of the vehicle 9 to a speed threshold (a step S33). Then, in a case where the speed of the vehicle 9 exceeds the speed threshold, the state determination part 20a determines that the state of the vehicle 9 is the travelling state (a step S34). On the other hand, in a case where the speed of the vehicle 9 is equal to or below the speed threshold, the state determination part 20a determines that the state of the vehicle 9 is the stopped state (a step S36).

Moreover, in a case where the position of the gearshift of the vehicle 9 is not the drive position (D) (No in the step S32), the state determination part 20a determines whether or not the position of the gearshift of the vehicle 9 is a reverse position (R) (a step S35).

In a case where the position of the gearshift of the vehicle 9 is the reverse position (R) (Yes in the step S35), the state determination part 20a determines, regardless of the speed of the vehicle 9, that the state of the vehicle 9 is the backward-moving state (a step S37).

Moreover, in a case where the position of the gearshift of the vehicle 9 is a park position (P) or a neutral position (N) (No in the step S35), the state determination part 20a determines that the state of the vehicle 9 is the stopped state (the step S36).

With reference back to FIG. 9, after the state determination part 20a performed the state determination process (the step S1a), a mode setter 20b receives the determined state of the vehicle 9 and then sets the operation mode based on the state of the vehicle 9 (a step S2a and after).

In a case where the state of the vehicle 9 is determined to be the travelling state or the backward-moving state (Yes in the step S2a), the mode setter 20b sets the operation mode to the image display mode (the step S3). After that, the operation controller 20c controls each processing portion of the image display system 10 to work according to the image display mode, same as the first embodiment.

On the other hand, in a case where the state of the vehicle 9 is determined to be the stopped state (No in the step S2a), the mode setter 20b sets the operation mode to the mirror mode (the step S7). After that, the operation controller 20c controls each processing portion of the image display system 10 to work according to the mirror mode, same as the first embodiment.

As described above, in the image display system 10 in the third embodiment, in the case where the position of the gearshift of the vehicle 9 is the drive position (D), the state determination part 20a determines, based on the speed of the vehicle 9, whether the state of the vehicle 9 is the travelling state or the stopped state. In the case where the position of the gearshift of the vehicle 9 is the reverse position (R), the state determination part 20a determines, regardless of the speed of the vehicle 9, that the state of the vehicle 9 is the backward-moving state. Then, in the case where the state of the vehicle 9 is determined to be the travelling state or the backward-moving state, the mode setter 20b sets the operation mode to the image display mode. In the case where the state of the vehicle 9 is determined to be the stopped state, the mode setter 20b sets the operation mode to the mirror mode.

For example, when parking the vehicle 9, the user often alternately repeats stop and travelling of a short time period, having the gearshift in the reverse position (R). In such a case, if the operation mode is continually changed according to the repeated stop and travelling of the vehicle 9, it is difficult for the user to see the situation of the surroundings of the vehicle 9 stably. In the image display system 10 in the third embodiment, in the case where the position of the gearshift of the vehicle 9 is the reverse position (R), regardless of the speed of the vehicle 9, the operation mode is not changed from the image display mode. Therefore, even in the case where the user alternately repeats stop and travelling of the vehicle 9 of a short time period, the operation mode is not changed from the image display mode so that the user can see the situation of the surroundings of the vehicle 9 stably.

### 4. Fourth Embodiment

Next, a fourth embodiment will be descried below. A configuration and a process of an image display system 10 in the fourth embodiment are substantially the same as the configuration and the process of the image display system 10 in the first embodiment. Therefore, a difference from the image display system 10 in the first embodiment will be mainly described below. In the first embodiment, the state determination part 20a determines the state of the vehicle 9, directly using a result of the comparison between the speed of the vehicle 9 and the speed threshold. However, in the fourth embodiment, in a case where a state of a vehicle 9 has continued that is a result of the comparison between the speed of the vehicle 9 and the speed threshold, a state determination part 20a determines the state of the vehicle 9.

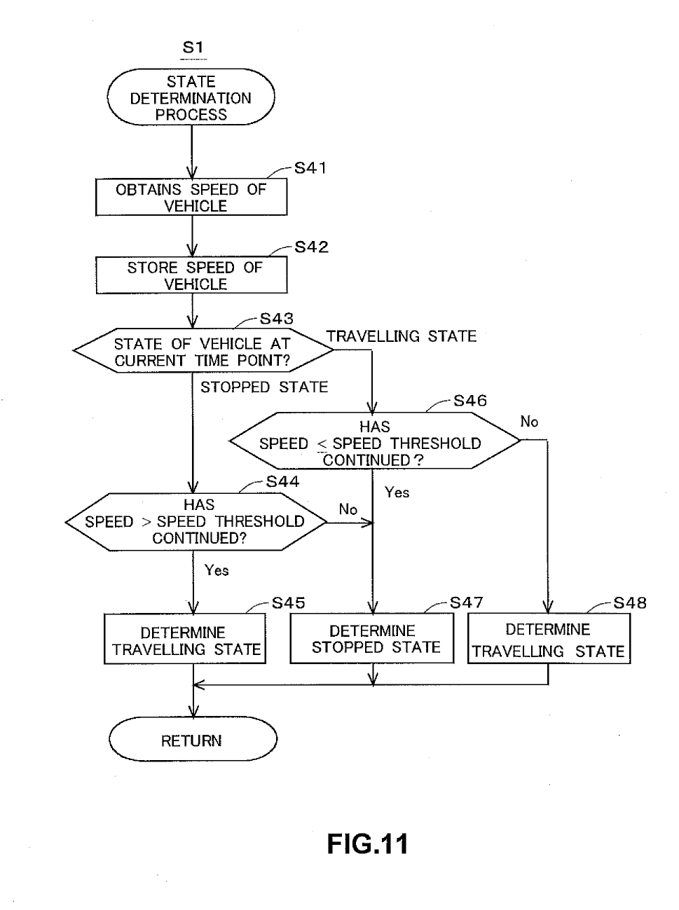

The process performed by the image display system 10 in the fourth embodiment is different from the process in the first embodiment, only in terms of the state determination process (the step S1 in FIG. 6). FIG. 11 illustrates a detailed flow of a state determination process in the fourth embodiment.

First, the state determination part 20a obtains a speed of the vehicle 9 at a current time point (a step S41). The state determination part 20a obtains the speed of the vehicle 9 based on a speed signal received by a signal receiver 24 from a vehicle speed sensor 91.

Next, the state determination part 20a stores the obtained speed of the vehicle 9 into a memory 25, as data (a step S42). As described above, the process is repeatedly performed by the image display system 10 in the predetermined time cycle. Since the state determination part 20a repeats the process of the step S42, the state determination part 20a sequentially stores the repeatedly obtained speed data of the vehicle 9 into the memory 25. The speed data of the vehicle 9 stored by the state determination part 20a is kept in the memory 25 at least for a predetermined time period (e.g., for three seconds).

Next, the state determination part 20a confirms the state of the vehicle 9 determined at a current time point (a step S43).

In a case where the state of the vehicle 9 determined at the current time point is the travelling state in the step S43, the state determination part 20a determines whether or not a state in which the speed of the vehicle 9 is equal to or below the speed threshold has continued (a step S46). The state determination part 20a determines whether or not the speed of the vehicle 9 is equal to or below the speed threshold for a predetermined time period (e.g., for three seconds), by referring to the speed data of the predetermined time period stored in the memory 25.

Then, in a case where the speed of the vehicle 9 is equal to or below the speed threshold for the predetermined time period (Yes in the step S46), the state determination part 20a determines that the state of the vehicle 9 is the stopped state (a step S47). In other words, the state determination part 20a changes the determined state of the vehicle 9 from the travelling state to the stopped state. On the other hand, in a case where the speed of the vehicle 9 is not equal to or below the speed threshold for the predetermined time period (No in the step S46), the state determination part 20a maintains the travelling state as the determined state of the vehicle 9 (a step S48).

In a case where the state of the vehicle 9 determined at the current time point is the stopped state in the step S43, the state determination part 20a determines whether or not a state in which the speed of the vehicle 9 exceeds the speed threshold has continued (a step S44). The state determination part 20a determines whether or not the speed of the vehicle 9 exceeds the speed threshold for a predetermined time period (e.g., for three seconds), by referring to the speed data of the predetermined time period stored in the memory 25.

Then, in a case where the speed of the vehicle 9 exceeds the speed threshold for the predetermined time period (Yes in the step S44), the state determination part 20a determines the state of the vehicle 9 is the travelling state (a step S45). In other words, the state determination part 20a changes the determined state of the vehicle 9 from the stopped state to the travelling state. On the other hand, in a case where the speed of the vehicle 9 does not exceed the speed threshold for the predetermined time period (No in the step S44), the state determination part 20a maintains the stopped state as the determined state of the vehicle 9 (a step S47).

The steps performed by the image display system 10 after the state determination part 20a performed the state determination process are the same as the steps in the first embodiment (FIG. 6). Therefore, in the case where the state of the vehicle 9 is determined to be the travelling state, the mode setter 20b sets the operation mode to the image display mode (the step S3), and in the case where the state of the vehicle 9 is determined to be the stopped state, the mode setter 20b sets the operation mode to the mirror mode (the step S7).

As described above, in the image display system 10 in the fourth embodiment, in the case where the speed of the vehicle 9 is equal to or below the speed threshold for the predetermined time period, the state determination part 20a determines that the state of the vehicle 9 is the stopped state. Therefore, the state of the vehicle 9 is not determined to be the stopped state unless the speed of the vehicle 9 is equal to or below the speed threshold for the predetermined time period. Moreover, in a case where the speed of the vehicle 9 exceeds the speed threshold for the predetermined time period, the state determination part 20a determines that the state of the vehicle 9 is the travelling state. Therefore, the state of the vehicle 9 is not determined to be the travelling state unless the speed of the vehicle 9 exceeds the speed threshold for the predetermined time period.

As described above, only in the case where the state of the vehicle 9 is maintained for the predetermined time period, which is a result of the comparison between the speed of the vehicle 9 and the speed threshold, the state determination part 20a changes the determined state of the vehicle 9. Thus, after the state determination part 20a determined the state of the vehicle 9, the state determination part 20a does not frequently change the determined state of the vehicle 9. Therefore, even if the vehicle 9 alternately repeats stop and travelling of a short time period, the operation mode is not changed frequently so that the user can use the display apparatus 3 stably. Moreover, the state determination part 20a is prevented from making a false determination of the state of the vehicle 9 because the state determination part 20a is not influenced by noise mixed into the speed signal for only a moment.

### 5. Modifications

The embodiments of the invention are described above. However, the invention is not limited to the foregoing embodiments, but various modifications are possible. Examples of other modifications will be described below. Any form of the embodiments described above and the modifications described below may be arbitrarily combined with one another.

For example, in the foregoing embodiments, the camera 1 captures images of the surrounding behind the vehicle. However, the camera 1 may capture images in a direction other than a backward direction showing the surrounding behind the vehicle. Moreover, the position of the display apparatus 3 is not limited to a position in which the display apparatus 3 is provided in the foregoing embodiments but may be provided to another position in the cabin of the vehicle 9.

In the foregoing embodiments, the mode setter 20b changes the operation mode based on the state of the vehicle 9. However, the operation mode may be changed, regardless of the state of the vehicle 9, by an operation made by the user with the operation button 4 and the like. In this case, until a predetermined time period passes from the operation made by the user or until an image display system 10 receives a predetermined command from the user, a mode setter 20b that sets an operation mode based on a state of the vehicle 9, may be disabled.

In the foregoing embodiments, the display apparatus 3 is changed to be in the non-display state by turning off the backlight 31. In response to that, a “black screen” is displayed on the display apparatus 3. However, the display apparatus 3 may be changed to be in the non-display state in another method, such as a method of stopping the image signal sent to the display apparatus 3. The term “black image” means an image having pixels at approx. zero (0) of a brightness value (luminance, brightness, etc.). For example, in a case where values of the pixels are expressed by RGB, the black image is expressed by R≠0, G≠0 and B≠0. Moreover, in a case where the values of the pixels are expressed by YCrCb, the black image is expressed by Y≠0.

In the foregoing embodiments, the state of the vehicle 9 is determined based on the speed signal indicative of the speed of the vehicle 9 or on the shift signal indicative of the position of the gearshift of the vehicle 9. However, the state of the vehicle 9 may be determined based on another signal relating to the vehicle 9, such as a signal indicative of an operation state of a parking brake. For example, in a case where the parking brake is in operation, a state of the vehicle 9 can be determined to be the stopped state.

In the foregoing embodiments, there are two operation modes for the image display system 10, one of which is the image display mode and the other is the mirror mode. However, the operation modes may include a mode other than the image display mode and the mirror mode.

In the foregoing embodiments, the function described as one block is not necessarily implemented by a single physical element, but may be implemented by separate physical elements. In the foregoing embodiments, the function described as a plurality of blocks may be implemented by a single physical element. Further, a process relating to one arbitrary function may be shared and implemented by apparatuses inside and outside the vehicle, and the function may be implemented as a whole by exchanging information via communications between those apparatuses.

Moreover, in the foregoing embodiments, all or any of the functions described to be implemented by software by executing programs may be implemented by electrical hardware circuit, and all or any of the functions described to be implemented by electrical hardware circuit may be implemented by software. Also, the function described as one block in the foregoing embodiments may be implemented by the cooperation of software and hardware.

While the invention has been shown and described in detail, the foregoing description is in all aspects illustrative and not restrictive. It is therefore understood that numerous other modifications and variations can be devised without departing from the scope of the invention.

What is claimed is:

1. A display control apparatus that controls a display apparatus having a display screen that includes a one-way mirror, the display control apparatus comprising:
a controller configured to:
obtain a captured image captured by a camera that captures an image of surroundings of a vehicle on which the display apparatus is provided;
determine a state of the vehicle based on a signal relating to the vehicle, the signal obtained by the controller; and
set an operation mode of the display apparatus based on the determined state of the vehicle, wherein
the operation mode is one of a first mode that displays the captured image on the display apparatus and a second mode that causes the display apparatus to be in a non-display state so that the display screen of the display apparatus functions as a mirror.

2. The display control apparatus according to claim 1, wherein
the controller determines whether the state of the vehicle is a travelling state or a stopped state based on the signal relating to the vehicle, and
in a case where the state of the vehicle is determined to be the travelling state, the controller sets the operation mode to the first mode, and in a case where the state of the vehicle is determined to be the stopped state, the controller sets the operation mode to the second mode.

3. The display control apparatus according to claim 2, wherein
the signal relating to the vehicle is a signal indicative of a speed of the vehicle, and
the controller determines whether the state of the vehicle is the travelling state or the stopped state based on the signal indicative of the speed of the vehicle.

4. The display control apparatus according to claim 3, wherein
in a case where the speed of the vehicle is equal to or below a predetermined speed for a predetermined time period, the controller determines that the state of the vehicle is the stopped state.

5. The display control apparatus according to claim 3, wherein
in a case where the speed of the vehicle exceeds a predetermined speed for a predetermined time period, the controller determines that the state of the vehicle is the travelling state.

6. The display control apparatus according to claim 2, wherein
the signal relating to the vehicle is a signal indicative of a position of a gearshift of the vehicle, and
the controller determines whether the state of the vehicle is the travelling state or the stopped state based on the signal indicative of the position of the gearshift of the vehicle.

7. The display control apparatus according to claim 1, wherein
the signal relating to the vehicle is a signal indicative of a position of a gearshift of the vehicle, and
in a case where the position of the gearshift of the vehicle is a drive position, the controller determines whether the state of the vehicle is a travelling state or a stopped state, according to a speed of the vehicle, and in a case where the position of the gearshift of the vehicle is a reverse position, the controller determines, regardless of the speed of the vehicle, the state of the vehicle is a backward-moving state, and
in a case where the state of the vehicle is determined to be one of the travelling state and the backward-moving state, the controller sets the operation mode to the first mode, and in a case where the state of the vehicle is determined to be the stopped state, the controller sets the operation mode to the second mode.

8. An image display system of a vehicle, the image display system comprising:
a display apparatus having a display screen including a one-way mirror, the display apparatus is provided in a cabin of the vehicle; and
a display control apparatus that controls the display apparatus and includes a controller configured to:
obtain a captured image captured by a camera that captures an image of surroundings of the vehicle;
determine a state of the vehicle based on a signal relating to the vehicle, the signal obtained by the controller; and
set an operation mode of the display apparatus based on the determined state of the vehicle, wherein
the operation mode is one of a first mode that displays the captured image on the display apparatus and a second mode that causes the display apparatus to be in a non-display state so that the display screen of the display apparatus functions as a mirror.

9. The image display system according to claim 8, wherein
the controller determines whether the state of the vehicle is a travelling state or a stopped state based on the signal relating to the vehicle, and
in a case where the state of the vehicle is determined to be the travelling state, the controller sets the operation mode to the first mode, and in a case where the state of the vehicle is determined to be the stopped state, the controller sets the operation mode to the second mode.

10. The image display system according to claim 9, wherein
the signal relating to the vehicle is a signal indicative of a speed of the vehicle, and
the controller determines whether the state of the vehicle is the travelling state or the stopped state based on the signal indicative of the speed of the vehicle.

11. The image display system according to claim 10, wherein
in a case where the speed of the vehicle is equal to or below a predetermined speed for a predetermined time period, the controller determines that the state of the vehicle is the stopped state.

12. The image display system according to claim 10, wherein
in a case where the speed of the vehicle exceeds a predetermined speed for a predetermined time period, the controller determines that the state of the vehicle is the travelling state.

13. The image display system according to claim 9, wherein
the signal relating to the vehicle is a signal indicative of a position of a gearshift of the vehicle, and
the controller determines whether the state of the vehicle is the travelling state or the stopped state based on the signal indicative of the position of the gearshift of the vehicle.

14. A display control method of controlling a display apparatus having a display screen that includes a one-way mirror and that is mounted in a vehicle, the display control method comprising the steps of:
(a) obtaining, by a controller, a captured image captured by a camera that captures an image of surroundings of the vehicle;
(b) determining, by the controller, a state of the vehicle based on a signal relating to the vehicle obtained by the controller; and
(c) setting, by the controller, an operation mode of the display apparatus based on the state of the vehicle determined by the step (b), wherein
the operation mode is one of a first mode that displays the captured image on the display apparatus and a second mode that causes the display apparatus to be in a non-display state so that the display screen of the display apparatus functions as a mirror.

15. The display control method according to claim 14, wherein
the step (b) determines whether the state of the vehicle is a travelling state or a stopped state, and
in a case where the state of the vehicle is determined to be the travelling state, the step (c) sets the operation mode to the first mode, and in a case where the state of the vehicle is determined to be the stopped state, the step (c) sets the operation mode to the second mode.

16. The display control method according to claim 15, wherein
the signal relating to the vehicle is a signal indicative of a speed of the vehicle, and
the step (b) determines whether the state of the vehicle is the travelling state or the stopped state based on the signal indicative of the speed of the vehicle.

17. The display control method according to claim 16, wherein
in a case where the speed of the vehicle is equal to or below a predetermined speed for a predetermined time period, the step (b) determines that the state of the vehicle is the stopped state.

18. The display control method according to claim 16, wherein
in a case where the speed of the vehicle exceeds a predetermined speed for a predetermined time period, the step (b) determines that the state of the vehicle is the travelling state.

19. The display control method according to claim 15, wherein
the signal relating to the vehicle is a signal indicative of a position of a gearshift of the vehicle, and
the step (b) deter nines whether the state of the vehicle is the travelling state or the stopped state based on the signal indicative of the position of the gearshift of the vehicle.

20. The display control method according to claim 14, wherein
the signal relating to the vehicle is a signal indicative of a position of a gearshift of the vehicle, and
in a case where the position of the gearshift of the vehicle is a drive position, the step (b) determines whether the state of the vehicle is a travelling state or a stopped state, according to a speed of the vehicle, and in a case where the position of the gearshift of the vehicle is a reverse position, the step (b) determines, regardless of the speed of the vehicle, the state of the vehicle is a backward-moving state, and
in a case where the state of the vehicle is determined to be one of the travelling state and the backward-moving state, the step (c) sets the operation mode to the first mode, and in a case where the state of the vehicle is determined to be the stopped state, the step (c) sets the operation mode to the second mode.
